(19) United States
(12) Patent Application Publication
(10) Pub. No.: US 2014/0344855 A1
(43) Pub. Date: Nov. 20, 2014

(54) METHOD AND APPARATUS FOR GENERATING AUTOMATIC MEDIA PROGRAMMING THROUGH VIEWER PASSIVE PROFILE

(71) Applicant: Greggory J. MORROW, Los Angeles, CA (US)

(72) Inventor: Greggory J. MORROW, Los Angeles, CA (US)

(21) Appl. No.: 14/452,249

(22) Filed: Aug. 5, 2014

Related U.S. Application Data
(63) Continuation-in-part of application No. 13/204,496, filed on Aug. 5, 2011.

(51) Int. Cl. H04N 21/2668; H04N 21/462; H04N 21/466; H04N 21/442; H04N 21/45

(52) U.S. Cl. CPC H04N 21/2668; H04N 21/44204; H04N 21/4532; H04N 21/4667; H04N 21/4622
USPC 725/34

(57) ABSTRACT

The system described herein works by eliminating the need for a viewer to actively select media. Instead, this new method creates a viewer passive profile by analyzing viewer and media metadata and then provides such media directly to the viewer through the system whenever the system is activated or whenever the user wants to watch it (time preference). Active selection of media by the viewer is no longer necessary. Instead, the viewer automatically receives his or her media profile preferences in a timely fashion.

### CROSS-REFERENCE TO RELATED APPLICATIONS

This patent application is a continuation-in-part of, U.S. patent application Ser. No. 13/204,496 filed on Aug. 5, 2011, which is incorporated by reference herein in its entirety.

### BACKGROUND OF THE SYSTEM

Since inception, viewers of media have faced the inherent need to actively select media programming for viewing. As media content has proliferated and become more varied as well as unstructured, this active selection process by the viewer has become tedious and stupefying. The system resolves the need to actively select media (e.g., through hand-held remote control unit, keyboard, direct media display access, etc.) by creating a passive profile by use of metadata (embedded and electronically stored descriptive, structural, administrative and other data about the viewer, such as age or sex, geographic location, profession or other demographic information, as well as about the media, such as drama, sports, comedy, variety, or other information, that the viewer tends to prefer based on monitoring the viewer's watching preferences over time and at specific times) and then streaming such media directly to the viewer through the system programming (there is no need to actively select via remote control or direct access). The viewer automatically receives his or her media profile preferences at the time it is desired to be viewed (what they want when they want it) without making an active selection.

In the past, viewers of media programming were offered such programming by computing a similarity metric between programs in a “user specified selected set” (see Method And Apparatus For Generating Television Program Recommendations Based On Similarity Metric, Schaffer et al.; U.S. Pat. No. 7,454,776) requiring the viewer to first decide on the programming to be viewed. Although this method of a selected set allowed for a reflection of the viewer's preferences, it still required the viewer to be “active” in what she or he wanted to view in order to formulate the set. The set would be “offered” for selection by the viewer through “electronic programming guides” to allow the viewer to “select one or more programs that the viewer found attractive for viewing. This past methodology did not go to the next step: automatically serving up “passive” streaming media based on such preferences by “fetching” metadata without requiring the viewer to make active selections at all and, instead, allowing the viewer to sit back, relax, and just watch what the viewer intuitively wants to view at the time and place they want to view it.

There are several intrinsic challenges with prior methods used to determine and offer viewer preferences. First, these methods required active selection by the viewer. If the viewer failed to make active and accurate selections of preferred programming, prior methods could not create a selection set or, if a selection set was offered, it would not be desired by the viewer. Second, past methods for viewer preference relied on electronic programming guides (AC Nielsen, TV Guide, cable channel guides, internet guides, Tivo, etc.) that were provided to the viewer in order to enable her or him to make such selections and, ultimately, allow the method to make recommendations of views. Since possible selections were primarily offered in linear fashion (“Channel 2” followed by “Channel 3” followed by “Channel 4” etc.), these programming guides were inherently flawed in not being capable of creating the optimal viewer profile. Instead, a profile was created based on first viewed or first selected programming and, therefore, resulted in inaccurate “similar shows” of media (e.g. false positive). Third, past methods for determining a viewer's preference for media were largely arbitrary by basing the selection of a “similarity metric” on supposed “weighted” factors (“station” or “title” or “actor”) that did not accurately reflect the individual viewer's preference for specific media (“title” may be given more weight by the method than that deemed necessary by the viewer, etc.). All these flaws created an imperfect means to determine viewer's distinct preference for media and then providing it in a passive means (no selection necessary).

### SUMMARY OF THE SYSTEM

The system described herein works by eliminating the need for a viewer to actively select media. Instead, this new method creates a viewer passive profile by analyzing viewer and media metadata and then provides such media directly to the viewer through the system whenever the system is activated or whenever the user wants to watch it (time preference). Active selection of media by the viewer is no longer necessary. Instead, the viewer automatically receives his or her media profile preferences in a timely fashion.

### BRIEF DESCRIPTION OF THE DRAWINGS

FIG. 1 is a flow diagram of an embodiment of the system.

FIG. 2 is a flow diagram illustrating an embodiment of the system in generating a user content preference profile.

FIG. 3 is a flow diagram of an embodiment of the system for rating available content based on the user profile.

FIG. 4 is a flow diagram illustrating and embodiment of the operation of the system when the user activates the system for use.

FIG. 5 is an example of an interface in an embodiment of the system.

FIG. 6 is an example of the flow of the system in an embodiment.

FIG. 7 is an example computer environment for implementing an embodiment of the system.

### DETAILED DESCRIPTION OF THE SYSTEM

The system provides a method and apparatus for selecting desired content for a user and then instantly presenting that content to the user upon initiation of the system. The system tracks content selected by a user and generates a profile of the user's preferred content. The system in one embodiment uses metadata and other data associated with content selected and viewed by the user to determine a type of content preferred by the user. In addition, the user may interact with the system to provide information about content preferred by the user. This may take the form of rating or grading content during viewing, responding to requests for information periodically generated by the system, or by completing a more comprehensive user profile for use by the system.

In another embodiment, the system allows the user to use a third party profile to select content for the user. For example, the user may find that the content preferences of a third party, such as a film or television critic, a friend, a celebrity, a web site, or some other third party, coincides with the preferences of the user. The user may adopt the profile or preferences of one or more third parties to replace, complement, or supplement the preferences of the user.

The system may use the preference data of the user to come up with an interest score on all available content and ranks the content in a list of highest score to lowest score. The system in one embodiment provides the highest scoring content to the user whenever the user activates the system. In another embodiment, the system scores the content by time of day and/or day of the week, and/or by some other temporal period, and presents the highest scoring content for that temporal period when the user activates the system.

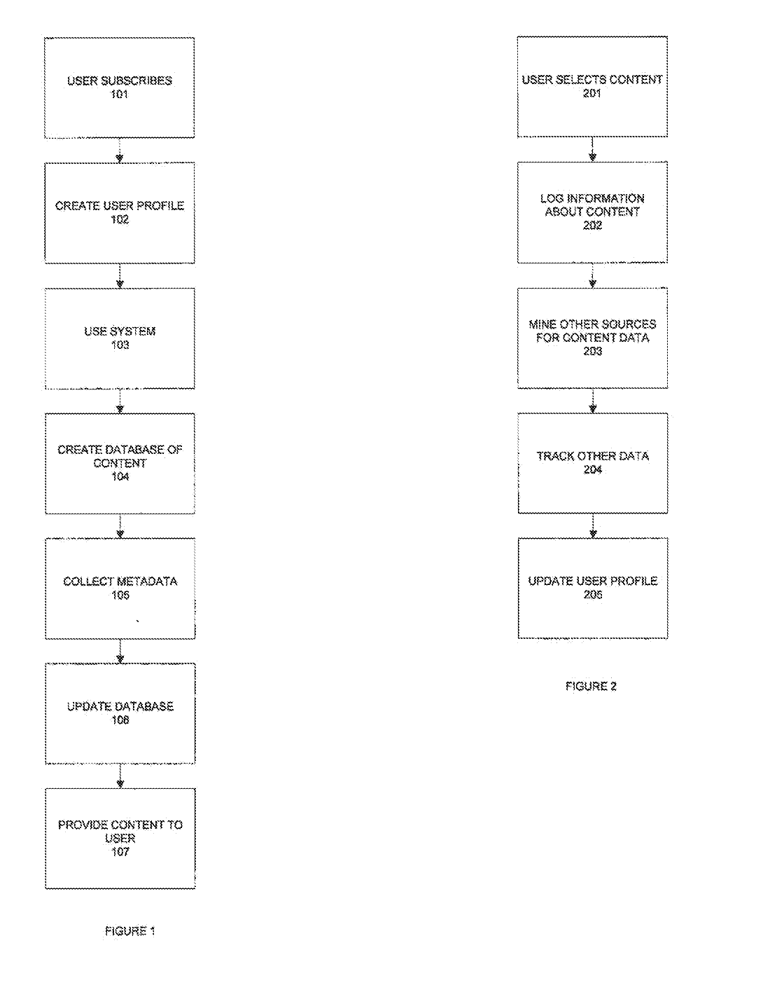

FIG. 1 is a flow diagram of an embodiment of the system. At step 101, a user subscribes to the system. At step 102 the user creates a user profile and provides some preference information. (in some embodiments, the user need not enter any profile information directly, but the system learns about the user from the user's choices and builds its own profile using subsequent steps described below). At step 103 the user begins using the system, watching television, choosing programs, recording programs, and the like. At step 104 the system creates a database of the content that is selected by the user. The system at step 105 collects metadata that is associated with the content. At step 106 the system uses the user database to update the profile of the user. At step 107 the system uses the data to identify content that will be provided instantly to the user when the user activates the system.

At step 201 the user selects content. At step 202 the system logs information about the content in the user database. This information can include any metadata associated with the content that is available with the content. Such data may include title, genre, lead actors, a summary description, etc. At step 203 the system may also seek additional information from other sources, such as via a network such as the internet. For example, the system may search the internet movie database (imdb.com) or wikipedia.org to obtain additional information including a more complete cast list, awards, additional plot description, or any information that may be used to characterize the content.

The system also tracks additional information about the content at step 204. This information includes the time of day and day of week when the content is being watched, how much of the content is watched (e.g. if it is an hour program, did the user watch the entire hour), whether it was a live presentation or a recorded presentation of content (whether from a DVD, CD, DVR, On-Demand, internet streaming, or the like), whether the user has watched the content before, whether the content is part of a series, and if the user provided any additional preference information (such as a thumbs up or thumbs down on Tivo, a star rating at an associated netflix account, etc.). At step 205 the system adds the information to the user's database to update the user's content preference profile.

FIG. 3 is a flow diagram of an embodiment of the system for rating available content based on the user profile. At step 301 the system retrieves content that is available to be viewed by the user. This can include content in a user media library, via on-line subscriptions, live broadcast schedules, and any other source of content available to the user. The system may look ahead as far as possible (when programming data is available) to obtain a large number of programs for analysis.

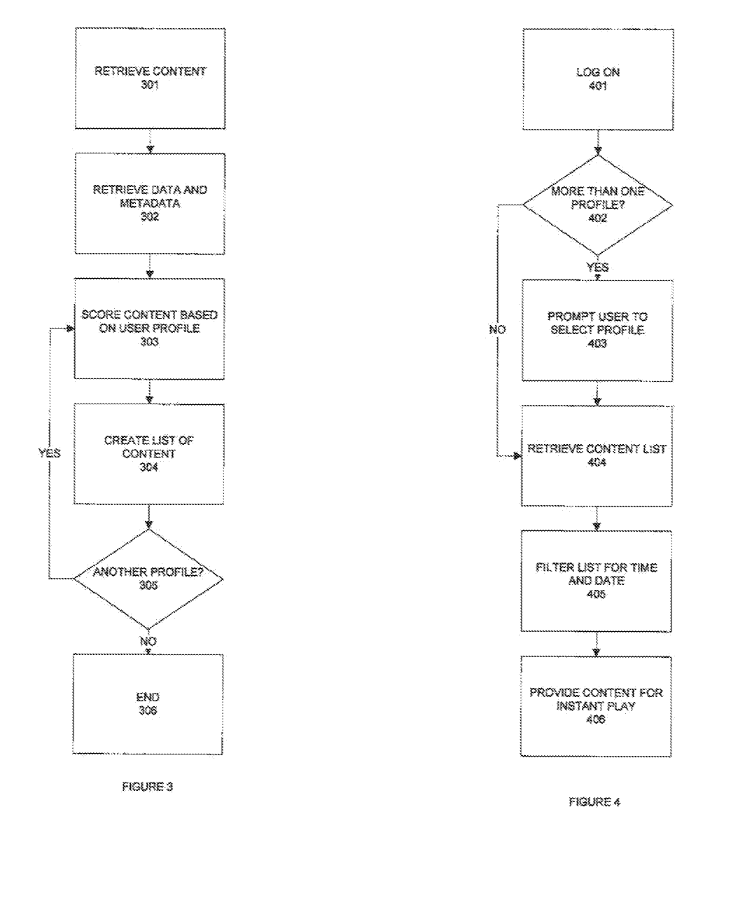

At step 302 the system retrieves metadata and external data about each program as described above in FIG. 2. At step 303 the system compares each piece of content to the user profile and assigns the content a score indicating how closely the content matches up with the user content preference profile. At step 304 the system creates a ranked list of the content based on the score.

At decision block 305 the system determines if there are other profiles for which content analysis should be performed. For example, there may be a plurality of registered users on the account. In addition, each user may elect to adopt one or more third party profiles as a way of selecting content. As noted above, the system can publish, export, or import the preference profiles of third parties and either make them available to users (or implement such third party preference profiles directly). The users themselves can share profile information as desired. For instance, there may be a celebrity, movie or television critic, blogger, friend, or other third party whose profile the user would like to adopt as his own.

If there is another profile at decision block 305, whether for another user or whether there are multiple profiles for a user, the system returns to step 303 to score the content for the next profile. If not, the system ends at step 306.

FIG. 4 is a flow diagram illustrating and embodiment of the operation of the system when the user activates the system for use. At step 401 the user activates the system. At step 402 the system determines if the user has more than one profile. If so, the system prompts the user at step 403 to select one of the profiles. If not, the system proceeds to step 404.

After the user has selected a profile at step 403, or if the user has only one profile, the system proceeds to step 404 and retrieves the appropriate content list for the user profile. At step 405 the system filters the content for the time and date. As noted above, the system includes a feature where it tracks temporal preferences of the user and ranks content accordingly. For example, the user may watch certain genres of content consistently at certain times. The user may prefer nature shows at bedtime, sitcoms in the evening, sports on weekends, news shows in the morning, etc. The system checks the time and date, and provides the preferred content to the user for that particular time.

The system provides the highest scoring show for the user to select instantly upon start up of the system at step 406. However, the system also provides an interface for the user to select any other available content if the user decides to watch something different. All content choices by the user are used to contribute to refining and updating the user profile, maximizing the chances of matching the user's desires with appropriate content (true positive).

In one embodiment, the system itself retrieves third party profiles and offers them to a user through the system interface. For example, the system may provide the ability to select from third parties such as rottentomatos.com, aintitcool.com, twitter, facebook, rankings of other system users, and the like.

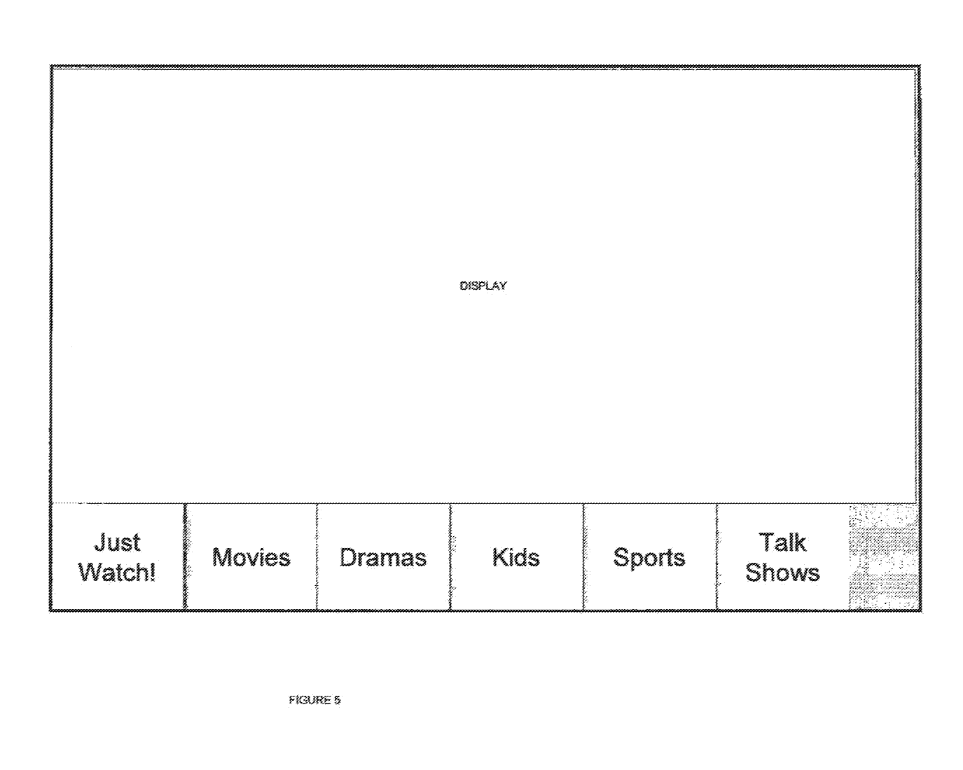

FIG. 5 is an example of a user interface in an embodiment of the system. The lower portion of the Device Screen would initially show the Main Menu of the system—located either horizontally at the bottom of the Device Screen or vertically on the Left side of the Screen, for example. The remainder of the Screen would instantly show the highest ranked show of the user.

The Main Menu overlays on top of the AV content showing in the screen. The Main Menu automatically recedes within a few seconds (can be set by viewer) after the viewer last presses any of the set remote controls except volume controls or as allowed by the set manufacturer. The Main Menu returns if the viewer presses any of the device remote control buttons except volume or other device maker pre-set controls.

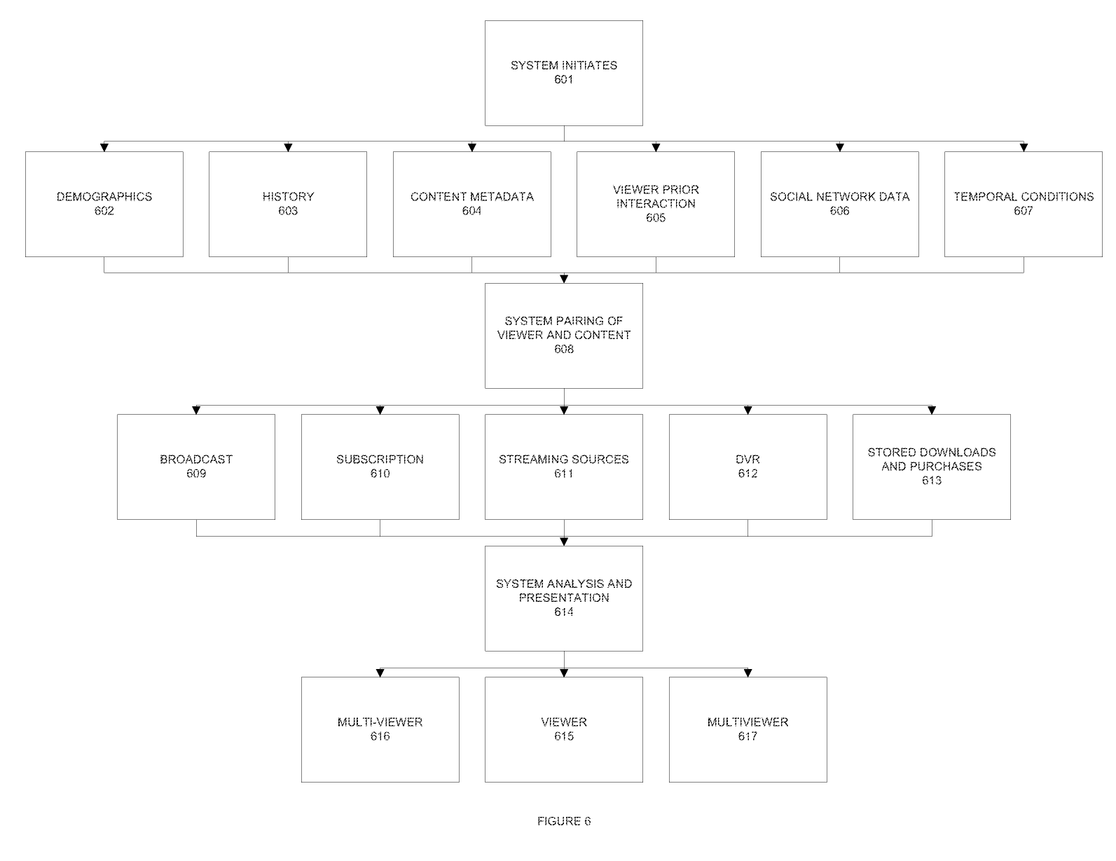

FIG. 6 illustrates the relationship of the operation of the system with content sources and users of the system. At block 601 the system initiates and begins operation. This may be via a user turning on the system via a remote control, smart-phone, Google Glass, voice activation, gesture activation, or via some other method of initiating the system. In some cases, the manner of initializing the system will provide the data necessary to identify the viewer/user. If there is only one registered user for a particular system, the system may default to a state that assumes the user has initiated the system. In other instances, the device, voice announce (e.g. “I am Joe”), image recognition, audio recognition, user gesture, keypad entry, tactile detection of a holder of a remote, user specific remotes with unique ID, or other indicia may identify the user who has initiated the system. In some cases, the user/viewer can indicate that two or more viewers have initiated the system. If the system does not have sufficient data to identify the user, the system may provide an onscreen query, or, in one embodiment, may provide the query on an input device used to activate the system (e.g. remote control, smartphone, and the like).

After the system has identified the viewer(s), the system will then pull the appropriate profile for the viewing party. This data is generated from a number of sources, examples of which are illustrated in FIG. 6. For example, the system may use demographics 602, including age, sex, height, weight, race, residence, and the like. The system also relies on prior viewing history of the user at block 603. The viewing history may have a pre-defined time limit (e.g. 30 days) or it may include all prior history, but apply an weighting algorithm so that changes in patterns can be accurately detected. The prior history can include time based weighting factors, as well as other factors such as whether a program that hasn't been watched in some time is beginning a new season, whether a new sports season has begun, and other weighting factors.

Block 604 includes content metadata, such as genre, (action, sports, reality, and the like) as well as type (movie, series, documentary, news, and the like). This metadata may be provided solely by the content provider. In other embodiments, the system will scrape metadata from other sources, such as reviews, third party guide data, social commentary, and the like. Block 605 stores prior action and interaction by the user, including selections made by the user as well as input preferences actively added to the system by the user. As noted above, the system builds a user profile both actively, by direct user input and passively, by tracking user choices and activity over time.

The system also tracks the social networks of the user (with permission in one embodiment) and stores data related to content in block 606. The system can parse texts, emails, posts, and “likes” by the user to determine possible preferences for content, and use this data as a weighting factor in the analysis and presentation of content to the user. Block 607 includes temporal conditions, history, and data as described above.

At block 608 the system begins the process of pairing content to the user/viewer. Block 608 has continuous access to content sources such as broadcast content 609, subscription sources 610 (e.g. cable, satellite, and the like), streaming sources 611 (e.g. Amazon, Netflix, Hulu, and the like), DVR content (or media hub) 612, and stored content of the user via prior movie downloads, content on networked PC's, data drives, and the like.

At block 614 the system uses all of this information to determine the best content to offer to the user at the present time. This process is accomplished in one embodiment using the steps of FIGS. 3 and/or FIG. 4. The process may be ongoing in the background at all times, with the highest scoring program changing based on factors such as temporal and other factors. The system then presents the user 615 (or additional viewers 616 and 617) with the best content for that user at that time, and allows the user to either agree, select from a ranked list of other high scoring content, or to manually choose the user's own preference for content.

Each choice of the user is fed back into the system to allow for additional refinement of the weighting and scoring algorithm, as well as updating the user profile.

The system can also be used to supplement existing rating systems (e.g. Nielson ratings and the like) because of the positive identification of the viewer(s) and the rich demographic data that is available for use. The system also provides time-shifting data for users who watch content at a later time (e.g. via DVR). The statistical information includes histogram data on the user in a plurality of fields that can be used to fine tune ratings and advertising information.

The system also contemplates the ability to tether profiles for groups of friends and/or “experts” (e.g. Rotten Tomatoes, Entertainment Weekly, TV Guide, box office performance, and the like). The system can provide ratings to the viewer of what the majority of the user's friends are watching at the current time or over some time period (e.g. “hot this week”). The user can even default to the crowd and allow the majority tastes of others to provide the strongest weight in the user's choices.

Embodiment of Computer Execution Environment (Hardware)

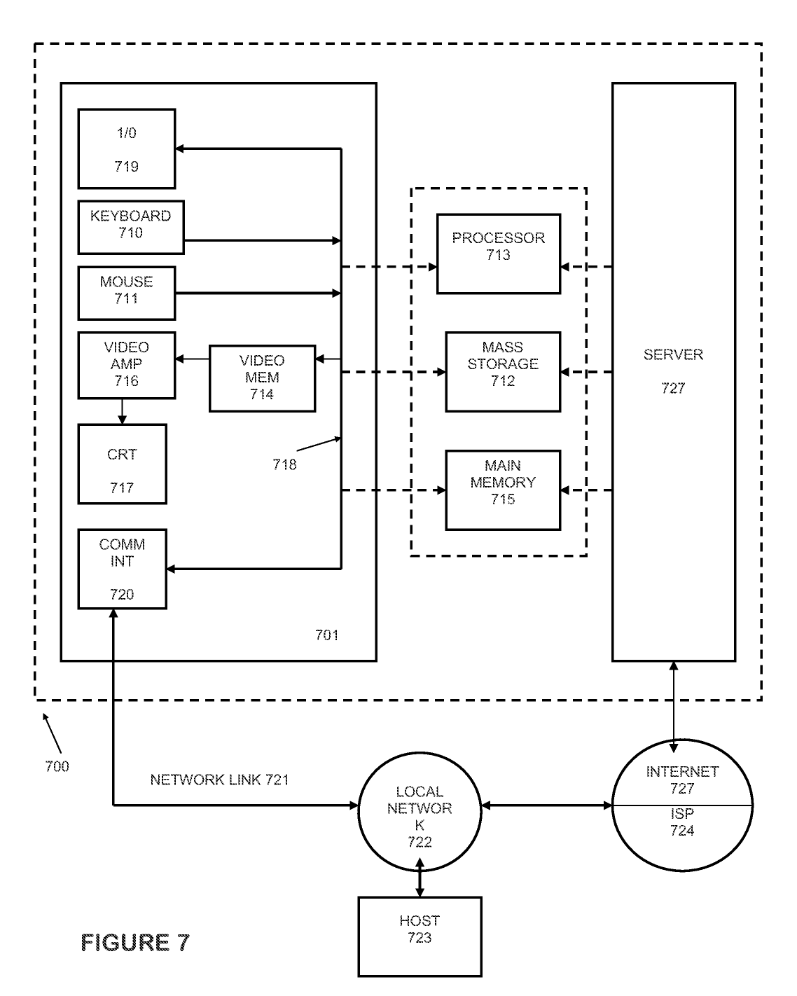

An embodiment of the system can be implemented as computer software in the form of computer readable program code executed in a general purpose computing environment such as environment 700 illustrated in FIG. 7, or in the form of bytecode class files executable within a Java.™. run time environment running in such an environment, or in the form of bytecodes running on a processor (or devices enabled to process bytecodes) existing in a distributed environment (e.g., one or more processors on a network). A keyboard 710 and mouse 711 are coupled to a system bus 718. The keyboard and mouse are for introducing user input to the computer system and communicating that user input to central processing unit (CPU 713. Other suitable input devices may be used in addition to, or in place of, the mouse 711 and keyboard 710. I/O (input/output) unit 719 coupled to bi-directional system bus 718 represents such I/O elements as a printer, A/V (audio/video) I/O, etc.

Computer 701 may be a laptop, desktop, tablet, smart-phone, or other processing device and may include a communication interface 720 coupled to bus 718. Communication interface 720 provides a two-way data communication coupling via a network link 721 to a local network 722. For example, if communication interface 720 is an integrated services digital network (ISDN) card or a modem, communication interface 720 provides a data communication connection to the corresponding type of telephone line, which comprises part of network link 721. If communication interface 720 is a local area network (LAN) card, communication interface 720 provides a data communication connection via network link 721 to a compatible LAN. Wireless links are also possible. In any such implementation, communication interface 720 sends and receives electrical, electromagnetic or optical signals which carry digital data streams representing various types of information.

Network link 721 typically provides data communication through one or more networks to other data devices. For example, network link 721 may provide a connection through local network 722 to local server computer 723 or to data equipment operated by ISP 724. ISP 724 in turn provides data communication services through the world wide packet data communication network now commonly referred to as the “Internet” 727 Local network 722 and Internet 727 both use electrical, electromagnetic or optical signals which carry digital data streams. The signals through the various networks and the signals on network link 721 and through communication interface 720, which carry the digital data to and from computer 700, are exemplary forms of carrier waves transporting the information.

Processor 713 may reside wholly on client computer 701 or wholly on server 727 or processor 713 may have its computational power distributed between computer 701 and server 727. Server 727 symbolically is represented in FIG. 7 as one unit, but server 727 can also be distributed between multiple “tiers”. In one embodiment, server 727 comprises a middle and back tier where application logic executes in the middle tier and persistent data is obtained in the back tier. In the case where processor 713 resides wholly on server 727, the results of the computations performed by processor 713 are transmitted to computer 701 via Internet 727, Internet Service Provider (ISP) 724, local network 722 and communication interface 720. In this way, computer 701 is able to display the results of the computation to a user in the form of output.

Computer 701 includes a video memory 714, main memory 715 and mass storage 712, all coupled to bi-directional system bus 718 along with keyboard 710, mouse 711 and processor 713.

As with processor 713, in various computing environments, main memory 715 and mass storage 712, can reside wholly on server 727 or computer 701, or they may be distributed between the two. Examples of systems where processor 713, main memory 715, and mass storage 712 are distributed between computer 701 and server 727 include thin-client computing architectures and other personal digital assistants, Internet ready cellular phones and other Internet computing devices, and in platform independent computing environments.

The mass storage 712 may include both fixed and removable media, such as magnetic, optical or magnetic optical storage systems or any other available mass storage technology. The mass storage may be implemented as a RAID array or any other suitable storage means. Bus 718 may contain, for example, thirty-two address lines for addressing video memory 714 or main memory 715. The system bus 718 also includes, for example, a 32-bit data bus for transferring data between and among the components, such as processor 713, main memory 715, video memory 714 and mass storage 712. Alternatively, multiplex data/address lines may be used instead of separate data and address lines.

In one embodiment of the invention, the processor 713 is a microprocessor such as manufactured by Intel, AMD, Sun, etc. However, any other suitable microprocessor or microcomputer may be utilized, including a cloud computing solution. Main memory 715 is comprised of dynamic random access memory (DRAM). Video memory 714 is a dual-ported video random access memory. One port of the video memory 714 is coupled to video amplifier 719. The video amplifier 719 is used to drive the cathode ray tube (CRT) raster monitor 717. Video amplifier 719 is well known in the art and may be implemented by any suitable apparatus. This circuitry converts pixel data stored in video memory 714 to a raster signal suitable for use by monitor 717. Monitor 717 is a type of monitor suitable for displaying graphic images.

Computer 701 can send messages and receive data, including program code, through the network(s), network link 721, and communication interface 720. In the Internet example, remote server computer 727 might transmit a requested code for an application program through Internet 727, ISP 724, local network 722 and communication interface 720. The received code maybe executed by processor 713 as it is received, and/or stored in mass storage 712, or other non-volatile storage for later execution. The storage may be local or cloud storage. In this manner, computer 700 may obtain application code in the form of a carrier wave. Alternatively, remote server computer 727 may execute applications using processor 713, and utilize mass storage 712, and/or video memory 715. The results of the execution at server 727 are then transmitted through Internet 727, ISP 724, local network 722 and communication interface 720. In this example, computer 701 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

Thus, a system and method for providing desired content is described.

What is claimed is:

1. An apparatus for presenting content for viewing comprising:
a processing system including,
a first memory for storing viewer profile information including viewer history and viewer social network data;
a second memory for storing content metadata and temporal relationships;
a plurality of content sources including streaming, stored, broadcast, and pay per view content;
a system analysis module for generating a content suggestion to a viewer based on the data stored in the memories.

2. The apparatus of claim 1 wherein the current temporal status comprises the time of day and day of the week.

3. The apparatus of claim 2 wherein the first user profile is a personal profile of the user.

4. The apparatus of claim 2 wherein the first user profile is a third party profile.

5. The apparatus of claim 2 further including a second user profile that may be selected by the user.
